(19) United States
(12) Patent Application Publication
(10) Pub. No.: US 2009/0138970 A1
(43) Pub. Date: May 28, 2009

(54) Method and System for Detecting Intrusions

(75) Inventors: Elvis Tombini, Paris (FR); Herve Debar, Louvigny (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 11/988,492

(22) PCT Filed: Jul. 6, 2006
(86) PCT No.: PCT/FR2006/050682

§ 371 Date: Jul. 14, 2008

(30) Foreign Application Priority Data
Jul. 8, 2005 (FR) 0507292

(51) Int. Cl. G06F 21/00

(52) U.S. Cl. 726/23

(57) ABSTRACT

A method of automatically detecting intrusions among events under surveillance. The method comprises comparing an event under surveillance to a set of patterns, each pattern being associated with a predetermined intrusion signature from a set of intrusion signatures, determining among said set of intrusion signatures a subset of intrusion signatures revealing a particular intrusion in said event under surveillance, and dynamically generating a new signature corresponding to said subset of intrusion signatures, said new signature being dedicated to recognizing said particular intrusion.

### TECHNICAL FIELD OF THE INVENTION

The invention relates to automatic intrusion detection and more particularly to generating signatures in an intrusion detection context.

### BACKGROUND OF THE INVENTION

The security of information systems relies on the deployment of intrusion detection systems (IDS), which effect surveillance of events occurring in an information system either by listening in to exchanges over the network or by surveillance of the operation of applications in the system hardware by means of log files and/or system calls.

These intrusion detection systems include intrusion detection probes, which are active components that analyze one or more data sources to find events characteristic of an intrusive activity and send alerts to an alert management module that centralizes the alerts coming from the probes and, where applicable, analyses all of them.

As a general rule, intrusion detection systems enable attacks against information systems (whether successful or not) to be updated in accordance with scenario-based or behavior-based intrusion detection.

The most widely used intrusion detection systems use scenario-based detection and are known as misuse intrusion detection systems. Scenario-based detection uses “intrusion signatures” (or attack signatures) to recognize and therefore characterize intrusions (or attacks) in a set of events. These intrusion signatures consist primarily of an “active principle”, documentation describing the attack or the vulnerability, and the name of the signature that defines the alert to be sent. Such intrusion signatures are written by an expert and stored in a file.

The “active principle” is a pattern that is searched for in the event under surveillance. The signatures used by intrusion detection systems therefore associate an alert name with an event recognized via the “active principle” of the signatures. In the context of scenario-based intrusion detection, the signatures characterize attacks. In this context, each active principle (or pattern) identifies a particular signature.

One method known in the field of scenario-based intrusion detection is described by Martin Roesch in “Lightweight Intrusion Detection for Networks”, Proceedings of LISA '99, pages 229-238, Seattle, Wash., USA, November 1999, USENIX Association.

Intrusion detection tools using that method test the signatures sequentially, i.e. the event under surveillance is compared with each signature and therefore with each associated pattern. The detection process is stopped either as soon as an attack signature is recognized (even if there remain signatures that have not been tested) and an alert associated with that signature has been sent or when there are no more signatures to be tested.

FIG. 4 is a relational diagram illustrating this sequential detection method where an alert A is associated with a single signature S. Similarly, a signature S is associated with a single pattern P and a single document D.

FIG. 5 illustrates another scenario-based method of detecting intrusions described by Magnus Almgren, Hervé Debar and Marc Dacier in “A Lightweight Tool for Detecting Web Server Attacks”, Proceedings of the 2000 ISOC Symposium on Network and Distributed Systems Security, pages 157-170, 2000.

That method is a composite detection method that analyses an event in two stages. The first stage compares an event to all the signatures S and therefore to each associated pattern P.

Unlike “sequential” detection, if a signature S is recognized, the analysis continues until there are no more signatures.

The second stage sends an alert A consisting of the signatures S that have been recognized. The combination of signatures is explained by the fact that the signatures can apply to specific elements of the event to be processed.

In this context, an alert A is no longer associated with a signature S but with a set (1, . . . , N) of signatures S. Each signature S nevertheless remains associated with a single pattern P and a single document D.

The drawback of those methods is that the information supplied to a security operator relates only to the vulnerability that the attack exploits. However, that vulnerability can be exploited in different ways and with different aims, and those two methods do not take these into account.

### OBJECT AND SUMMARY OF THE INVENTION

The present invention consists in a method of automatically detecting intrusions among events under surveillance, characterized in that it comprises:
comparing an event under surveillance to a set of patterns, each pattern being associated with a predetermined intrusion signature from a set of intrusion signatures;
determining among said set of intrusion signatures a subset of intrusion signatures revealing a particular intrusion in said event under surveillance; and
dynamically generating a new signature corresponding to said subset of intrusion signatures, said new signature being dedicated to recognizing said particular intrusion.

This method therefore creates new signatures dedicated to the recognition of a very specific intrusion or attack, offering a security operator a more precise diagnosis based on existing signatures.

The new signature advantageously causes an alert to be sent that corresponds to the event associated with said particular intrusion.

Thus each alert supplies pertinent and precise information about the nature of the intrusion.

According to one particular feature of the present invention, dynamic generation of the new signature includes assembling patterns associated with each of the signatures of said subset of intrusion signatures obtained to form a new pattern associated with said new signature.

This optimizes the quality of the diagnosis and the richness of a signature base continually and in real time and the new signature is created during intrusion detection itself.

According to another particular feature of the present invention, determining a signature revealing the particular intrusion in said subset of intrusion signatures includes the use of a function for matching properties of said event under surveillance and the pattern associated with said signature.

Thus the subset of intrusion signatures can be determined in a simple and fast manner.

The new signature is advantageously added to the set of predetermined intrusion signatures so that each new event is compared with that new signature.

The reliability and the performance of intrusion detection therefore improve continually.

The invention is also directed to an intrusion detection module including a sensor for sensing events under surveillance in an information system, characterized in that it further includes:
comparison means for comparing an event under surveillance to a set of patterns associated with a set of predetermined intrusion signatures;
determination means for determining in said set of predetermined intrusion signatures a subset of intrusion signatures revealing a particular intrusion in said event under surveillance; and
production means for dynamically generating a new signature that corresponds to said subset of intrusion signatures and is dedicated to recognizing said particular intrusion.

This intrusion detection module creates new signatures offering precise detection of intrusions with optimum efficacy.

The module further includes sending means for sending a management module an alert corresponding to the event associated with said particular intrusion.

The intrusion detection module therefore sends the management module an alert including pertinent and precise information as to the nature of the intrusion or attack.

The module further includes storage means for adding the new signature to the set of predetermined intrusion signatures already stored in said storage means so that each new event is compared to that new signature.

The intrusion detection module therefore continually improves intrusion detection reliability and performance.

The invention is further directed to an information system under surveillance including an alert management module, an alert presentation console, and a plurality of intrusion detection modules having the above features.

This therefore strengthens the protection of the information system.

The invention is further directed to a computer program including instructions for executing the above intrusion detection method when it is executed by a data processing system.

The invention is further directed to data storage means including computer program code instructions for executing the steps of a method having the above features.

### BRIEF DESCRIPTION OF THE DRAWINGS

Other particular features and advantages of the invention emerge on reading the description given below by way of non-limiting illustration and with reference to the appended drawings, in which:

FIG. 1 is a diagrammatic view of an information system under surveillance including an intrusion detection system of the invention;

FIG. 2 is a diagrammatic view of an intrusion detection module of the invention;

FIG. 3 is a flowchart illustrating the intrusion detection method of the invention; and

FIGS. 4 and 5 are prior art relational diagrams.

### DETAILED DESCRIPTION OF EMBODIMENTS

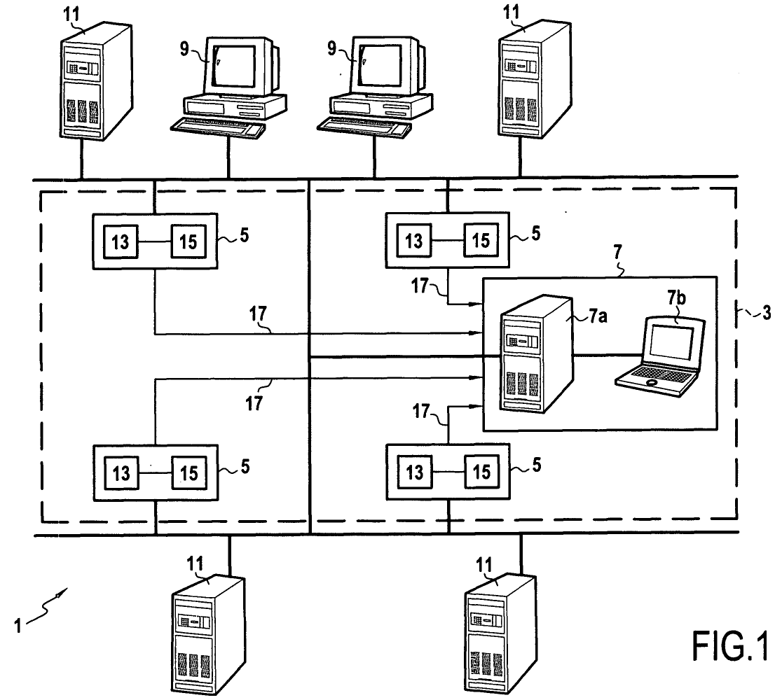

FIG. 1 illustrates one example of an information system 1 under surveillance including an intrusion detection system 3 comprising intrusion detection modules 5 and an alert management module 7.

The intrusion detection modules 5 provide surveillance of events originating outside or inside a network of the information system under surveillance, which comprises workstations 9 and servers 11 communicating with external networks (not shown).

The alert management module 7 can include a host 7a dedicated to processing alerts and a console 7b for presenting alerts to a security operator.

According to the invention, each intrusion detection module 5 consists mainly of an intrusion detection probe 13 connected to a signature generator 15.

Generally speaking, if a probe 13 detects an intrusion an alert corresponding to the event associated with that intrusion is sent by the intrusion detection module 5 to the management module 7 (arrow 17).

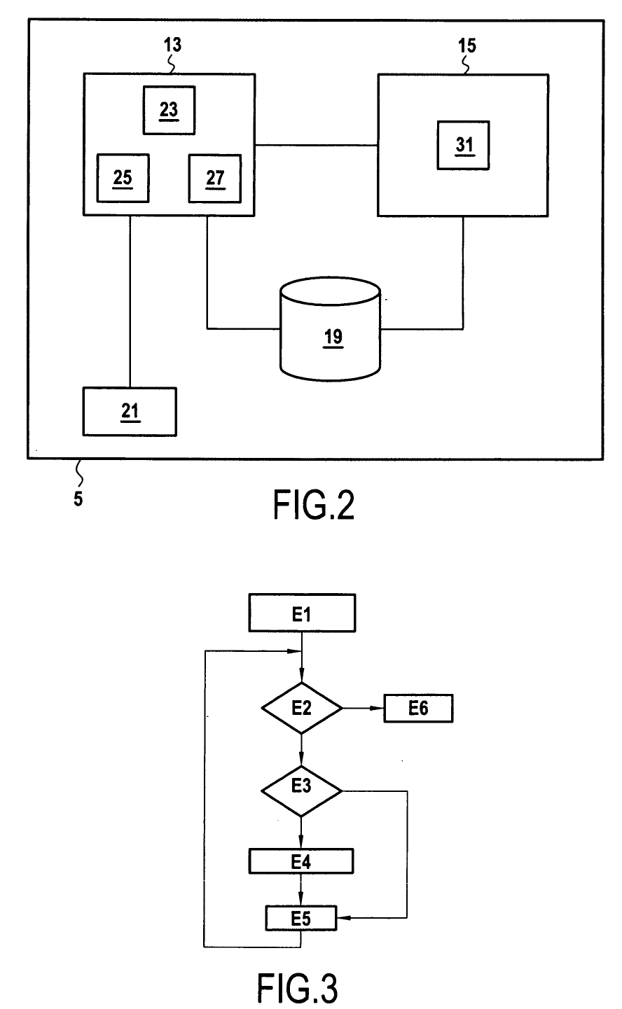

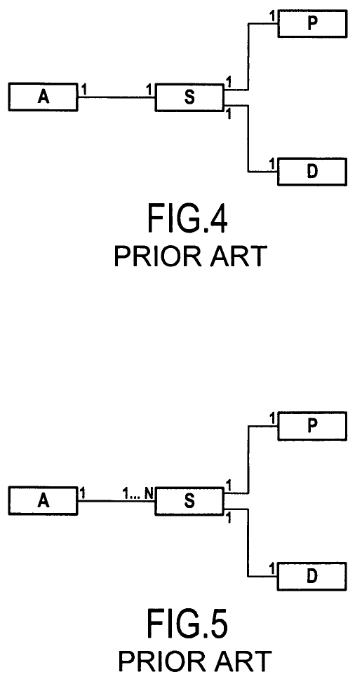

FIG. 2 shows one example of an intrusion detection module 5 more precisely including an intrusion detection probe 13, a signature generator 15, storage means 19, and sending means 21. Note, however, that the storage means 19 can also be located in the alert management module 7 or any other element of the intrusion detection system 3.

In this example, the intrusion detection probe 13 includes a sensor 23, comparison means 25 and determination means 27.

The event sensor 23 provides surveillance of a set of events occurring in the information system 1. As a general rule, an event is an action on the information system 1 and can have one or more parameters.

For example, an event can be an http request whereby a client requests a resource from a web server 11. A record of this event can be found in the log file of the server 11.

Furthermore, the comparison means 25 compare the event under surveillance to a set of patterns associated with a set of predetermined intrusion signatures stored in the storage means 19. Note that a pattern corresponds to each predetermined signature.

In addition, from the set of intrusion signatures, the determination means 27 determine a subset of intrusion signatures revealing a particular intrusion in the event under surveillance.

This figure also shows that the signature generator 15 includes production means 31 for dynamically generating a new signature that corresponds to said subset of intrusion signatures and is dedicated to recognition of the particular intrusion.

By way of example, consider an event E corresponding to an http request to a web server 11 of the form “GET/scripts/..%35c../winnt/system32/cmd.exe?/c+dir”.

This request is a typical manifestation of the activity of the “Nimda” worm. This event can therefore trigger at least two signatures, depending on the intrusion detection system.

The first signature S1 is a “use of malicious code” defined by the following name and pattern:
signature name: IIS Unicode directory traversal attempt
pattern searched for: “%35c”

The second signature S2 is a “command execution attempt” defined by the following name and pattern:
signature name: Windows command execution attempt
pattern searched for: “cmd.exe”

These two signatures S1 and S2, taken independently, do not indicate to the security operator that this is an activity deriving from the Nimda worm.

However, according to the invention, the intrusion detection module 5 combines the two activated signatures into a single signature in order to describe a specific event.

The comparison means 25 compare the event E to the set of predetermined intrusion signatures and the determination means 27 determine that the subset of intrusion signatures revealing the intrusion in the event E under surveillance consists of the above two signatures S1 and S2. The production means 31 also create a new signature S corresponding to the subset of intrusion signatures formed by the signatures S1 and S2. This new signature S is defined by a group or assembly of patterns associated with each of the signatures S1 and S2, for example by means of an “and” logic operator. The signature generator 15 injects this new signature into or adds it to the storage means 19; each new event will therefore be compared to this new signature.

The signature S resulting from activation of the above two signatures S1 and S2 can therefore be dedicated to recognizing the specific intrusion “Nimda worm activity” defined by the following name and pattern:
signature name: Nimda attempt
patterns searched for: “%35c” and “cmd.exe”.

The intrusion detection module 5 then searches for the two patterns “%35c” and “cmd.exe” of this new signature in each new event submitted to it. If this signature is activated, then the event associated with this intrusion is catalogued as a manifestation of the activity of the Nimda worm and the sending means 21 send an alert corresponding to this event to the management module 7. The intrusion detection module 5 therefore sends the management module an alert including more pertinent and more precise information as to the nature of the intrusion.

Note that the intrusion detection module 5 can be implemented by a data processing system (not shown) conventionally including a central processor unit connected by buses to a memory, an input unit, and an output unit. The data processing system can additionally be used to execute a computer program including instructions for executing the intrusion detection method of the invention.

FIG. 3 is a flowchart illustrating the intrusion detection method of the invention.

The step E1 is an initialization step in which a set of n+1 patterns P={pᵢ, iε{0, . . . n}} is defined. Each pattern is associated with a predetermined intrusion signature from a set of intrusion signatures stored in the storage means 19. The new pattern to be created, referred to as a “metapattern”, is initially empty. An event E is to be processed and the processing begins with i=0.

The steps E2 to E5 form a loop for comparing the event E under surveillance to the set P of patterns corresponding to the set of intrusion signatures to create dynamically a new signature dedicated to recognizing a particular intrusion and corresponding to a subset of intrusion signatures.

More particularly, the step E2 is an iterative test verifying if the n+1 patterns of the set P have been processed. Accordingly, if the index i designating the pattern pᵢ is less than or equal to n+1 (i.e. if i<n+1), then the next step is the step E3.

In the step E3, the event E is compared to the pattern pᵢ associated with a predetermined intrusion signature, for example using an algorithm match (pᵢ, E) for matching properties of the event E under surveillance and the pattern pᵢ of the predetermined intrusion signature. This matching algorithm is a Boyer-Moore pattern matching algorithm, for example.

Iteration of the test steps E3 determines a subset of intrusion signatures revealing a particular intrusion in the event E under surveillance.

Thus if the outcome of the test of the step E3 is positive, i.e. if the pattern pᵢ is recognized by the matching algorithm, then the next step is the step E4.

In the step E4, the pattern pᵢ that has been recognized is assembled to a new pattern (i.e. a metapattern). For example, this assembly can be effected by means of logic operators and/or quantizers.

For example, the assembly is effected by an “and” conjunction of the various patterns associated with each of the signatures of the subset of signatures by means of the conjunction of a pattern matching engine, i.e.: metapattern=conj (metapattern, pᵢ)=metapattern [symbol] p₁.

Then, after the step E4, and even if the outcome of the test of the step E3 is negative, the next step is the step E5 in which the index i is incremented (i=i+1) before looping to the step E2.

Finally, if the event E under surveillance has been compared to all the patterns of the set P, i.e. if the index i of the test E2 is not less than or equal to n+1, then the next step is the step E6 for sending back the new pattern formed in this way defining the new signature.

When it has been generated, the new signature is added to the set of predetermined intrusion signatures so that each new event is compared to the new signature.

Thus in contrast to the prior art, which uses the patterns in an atomic way (i.e. each pattern is associated with a single signature and during the intrusion detection phase an event under surveillance is compared with each signature in a unitary way), the method according to the invention is based on what might be called “composite detection”. In other words, from signatures associated with an intrusion (or attack), this method creates a new signature dedicated to recognizing that attack. This new signature uses the patterns of the signatures that revealed the attack.

Note that the phase of creating a signature dedicated to an attack proceeds during intrusion detection itself. The new signature is then used with the other signatures and the process starts over to analyze a new event.

1. A method of automatically detecting intrusions among events under surveillance, comprising the steps of:
comparing an event under surveillance to a set of patterns, each pattern being associated with a predetermined intrusion signature from a set of intrusion signatures;
determining among said set of intrusion signatures a subset of intrusion signatures revealing a particular intrusion in said event under surveillance; and
dynamically generating a new signature corresponding to said subset of intrusion signatures, said new signature being dedicated to recognizing said particular intrusion.

2. The method according to claim 1, wherein said new signature causes an alert to be sent that corresponds to the event associated with said particular intrusion.

3. The method according to claim 1, wherein dynamic generation of the new signature includes assembling patterns associated with each of the signatures of said subset of intrusion signatures obtained to form a new pattern associated with said new signature.

4. The method according to claim 1, wherein determining a signature revealing the particular intrusion in said subset of intrusion signatures includes the use of a function for matching properties of said event under surveillance and the pattern associated with said signature.

5. The method according to claim 1, wherein the new signature is added to the set of predetermined intrusion signatures so that each new event is compared with that new signature.

6. An intrusion detection module comprising:
a sensor (23) for sensing events under surveillance in an information system (1);
comparison means (25) for comparing an event under surveillance to a set of patterns associated with a set of predetermined intrusion signatures;
determination means (27) for determining in said set of predetermined intrusion signatures a subset of intrusion signatures revealing a particular intrusion in said event under surveillance; and
production means (31) for dynamically generating a new signature that corresponds to said subset of intrusion signatures and is dedicated to recognizing said particular intrusion.

7. The intrusion detection module according to claim 6, comprising sending means (21) for sending a management module an alert corresponding to the event associated with said particular intrusion.

8. The intrusion detection module according to claim 6, further comprising storage means (19) for adding the new signature to the set of predetermined intrusion signatures already stored in said storage means so that each new event is compared to that new signature.

9. An information system under surveillance including an alert management module (7), an alert presentation console, and a plurality of intrusion detection modules (5) according to claim 6.

10. A computer program including instructions for executing the intrusion detection method according to claim 1, when it is executed by a data processing system.

11. Data storage means including computer program code instructions for executing the steps of a method according to claim 1.
